(19) United States
(12) Patent Application Publication
(10) Pub. No.: US 2003/0204388 A1
(43) Pub. Date: Oct. 30, 2003

(54) Automated random verification of complex and structurally-variable systems

(75) Inventors: Andrea J. Rodriguez, Superior, CO (US); Steven R. Edwards, Boulder, CO (US); Christopher M. Giles, Lafayette, CO (US); Randy S. Miller, Longmont, CO (US)

Correspondence Address: LSI LOGIC CORPORATION, 1621 BARBER LANE, MS: D-106 LEGAL, MILPITAS, CA, 95035, US

(73) Assignee: LSI LOGIC CORPORATION

(21) Appl. No.: 10/132,492

(22) Filed: Apr. 25, 2002

(51) Int. Cl. G06F 17/50

(52) U.S. Cl. 703/14

(57) ABSTRACT

An apparatus comprising a system configuration generator, a system builder and a simulation verification environment. The system configuration generator may be configured to generate a random system configuration file of a structurally variable and complex system. The system builder may be configured to build a system level netlist in response to the random system configuration file. The simulation verification environment may be configured to verify the structurally variable and complex system in response to the system level netlist. The simulation verification environment may be configured to provide automatic random verification of the system in response to the random system configuration file.

### CROSS REFERENCE TO RELATED APPLICATIONS

The present application may relate to co-pending application Ser. No. 09/915,806, filed Jul. 26, 2001, which is hereby incorporated by reference in its entirety.

### FIELD OF THE INVENTION

The present invention relates to a method and/or architecture for automated verification generally and, more particularly, to a method and/or architecture for automated random verification of complex and structurally variable systems.

### BACKGROUND OF THE INVENTION

Conventional random verification methods manually generate a limited number of systems and run customized stimuli through each of the systems. However, such approaches are not efficient for complex and variable system verification.

In complex and structurally variable systems a high number of possible combinations of system structures, configurations, stimuli, and responses are present. Conventional random verification systems do not adequately cover the vast range of possible system conditions. It is impractical to test an adequate portion of such combinations using conventional approaches. Furthermore, the verification tests are specific to each system under test and are not easily adaptable.

It is generally desirable to provide adequate automated random verification of complex and structurally variable systems that can be easily adapted between systems.

### SUMMARY OF THE INVENTION

The present invention concerns an apparatus comprising a system configuration generator, a system builder and a simulation verification environment. The system configuration generator may be configured to generate a random system configuration file of a structurally variable and complex system. The system builder may be configured to build a system level netlist in response to the random system configuration f file. The simulation verification environment may be configured to verify the structurally variable and complex system in response to the system level netlist. The simulation verification environment may be configured to provide automatic random verification of the system in response to the random system configuration file.

The objects, features and advantages of the present invention include providing a method and/or architecture for automated random verification of complex and structurally variable systems that may (i) provide automated system generation, stimulus, and verification, (ii) increase the number and variety of possible system structures, configurations, and bus traffic combinations that are testable, and/or (iii) include scenarios that are not typically tested or anticipated by the designer/verifier.

### BRIEF DESCRIPTION OF THE DRAWINGS

These and other objects, features and advantages of the present invention will be apparent from the following detailed description and the appended claims and drawings in which:

FIG. 1 is a block diagram of a preferred embodiment of the present invention;

FIG. 2 is a detailed block diagram of the circuit of FIG. 1; and

FIG. 3 is a flow chart illustrating an operation of the present invention.

### DETAILED DESCRIPTION OF THE PREFERRED EMBODIMENTS

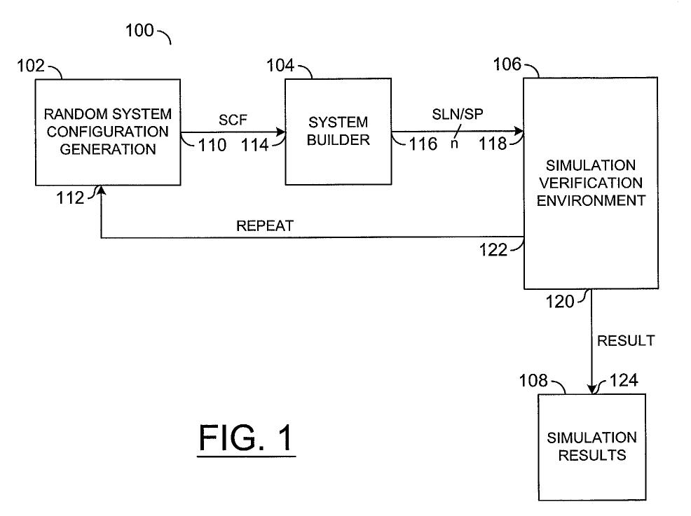

Referring to FIG. 1, a block diagram of a circuit (or system) 100 is shown in accordance with a preferred embodiment of the present invention. The system 100 may be useful in the verification of complex and structurally variable systems. In particular, the system 100 may provide automated random verification of complex and structurally variable systems. The system 100 may be implemented in hardware and/or software.

The system 100 is shown comprising a random system configuration generation block (or circuit) 102, a system builder block (or circuit) 104, a simulation verification environment (SVE) block (or circuit) 106 and a simulation results block (or circuit) 108. The random system configuration generation block 102 may have an output 110 that may present a signal (e.g., SCF) and an input 112 that may receive a signal (e.g., REPEAT). The signal SCF may be a system configuration file. The system configuration file SCF may be randomly generated by the system configuration generation block 102. The system configuration file SCF may be representative of a random generation of a variable system under test.

The system builder block 104 may have an input 114 that may receive the signal SCF and an output 116 that may present a number of signals (e.g., SLN and SP). The signal SLN may be a system level netlist. The signal SP may be system parameters. The parameters SP may represent specific system parameters according to a particular configuration of the variable and complex system under test as indicated by the SCF.

The simulation verification environment block 106 may have a number of inputs 118 that may receive the signals SLN and SP, an output 120 that may present a signal (e.g., RESULT) and an output 122 that may present the signal REPEAT. The signal REPEAT may initiate a repeat verification simulation for another randomly generated system of the complex and variable system under test, as indicated by the configuration file SCF. The signal RESULT may indicate that the simulation verification process 100 is complete. The simulation results block 108 may have an input 124 that may receive the signal RESULT. The simulation results block 108 may present the final simulation results (e.g., the signals SLN and SP) to an end user (not shown) via the signal RESULT.

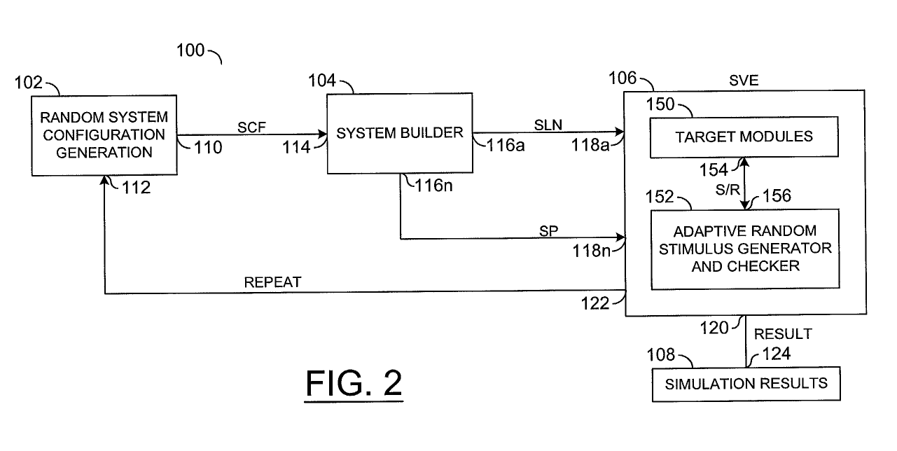

Referring to FIG. 2, the SVE 106 is shown comprising a target modules block (or circuit) 150 and an adaptive random stimulus generation and checker block (or circuit) 152. The target modules block 150 may have an input/output 154 that may receive/present a number of signals (e.g., S and R). The adaptive random stimulus generation and checker block 152 may have an input/output 156 that may present/receive the signals S and R. The signals S and R may be stimulus/responses. The stimulus/responses S and R may be configured to test the system level netlist SLN in connection with the target modules 150. The target modules 150 may represent a number of devices (not shown) the system under test is to interface. The target modules 150 may typically communicate through a bus (not shown).

The adaptive random stimulus generator and checker block 152 may be configured to generate the stimulus S. The stimulus S may then be presented to the target modules 150. The target modules 150 may then attempt to verify operation of the stimulus S and generate responses R. The responses R may indicate successful or unsuccessful verification of a particular configuration under test (SCF) with the target modules 150.

The system configuration file SCF may indicate a particular type of configuration (e.g., a system) for the structurally variable system under test. Each system generated by the random system configuration generation block 102 (as indicated by the configuration file SCF) may be variably configured. The random system configuration generation block 102 may take into account the structural and complex variables that may change in the system under test. For example, random system configuration generation block 102 may take into account (i) bus type, (ii) number of buses, (iii) number of masters, (iv) number of slaves, (v) number of ports specific to a module, (vi) special module slaves and masters as well as their placement on the busses, (vii) FIFO size, (viii) latency through the system, (ix) block or non-blocked bus mode, and/or (x) other appropriate variables.

In each generated system configuration file SCF the system variables may be different. The random system configuration generation block 102 may take interdependence into consideration. The random system configuration generation block 102 may also take the targeted modules 150 into consideration. Such a configuration may allow the random system configuration generation block 102 to randomly generate the system configuration file SCF each time the process 100 is re-initiated (e.g., a verification loop) via the signal REPEAT.

Depending on the configuration of the complexity and variable system under test, it may be necessary to provide stimulus S that may target specific areas (e.g., a number of busses, master devices, etc.). The adaptive random stimulus generator and checker block 152 may provide such a configuration. For example, the random stimulus S may test (i) register configuration specific to a tested module, (ii) grant removed and given back to master devices, (iii) burst type, (iv) locked and un-locked bus transactions, (v) a number of beats, (vi) beat delay, (vii) slave devices flushed, (viii) data, (ix) back-to-back or not back-to-back transactions, and/or (x) other appropriate stimuli. Furthermore, the adaptive random stimulus generator and checker block 152 may generate random data and stimulus S to test even more possible combinations of configuration and data. The adaptive random stimulus generator and checker block 152 may generate and test more random scenarios for each particular system configuration.

During operation, the random system configuration generator block 102 may generate the system configuration file SCF. The file SCF may specify a randomly generated system composed of bus functional models, target modules, and their respective interconnections. The system configuration file SCF may then be presented to the system builder block 104. The system builder block 104 may generate the system level netlist SLN and the system parameters SP of the system described by the system configuration file SCF. The system level netlist SLN and the system parameters SP may then be presented to the SVE 106.

The system level netlist SLN, the target modules block 150 and the adaptive random stimulus generator and checker block 152 may form the system verification environment 106. The target modules 150 are generally within the SVE 106. The target modules 150 may store a number of configurable devices (modules) to be tested. The SVE 106 may be executed to simulate and verify correctness of the system level netlist SLN with the target modules 150. The target modules 150 may be implemented as any appropriate type devices to meet the design criteria of a particular application. The verification may be monitored by the adaptive random stimulus generator and checker block 152 via the interface signals S and R. The random stimulus and response signals S and R generated by the blocks 152 and 150, respectively, may be automatically adapted to the generated system based on the system parameters SP supplied by the system builder block 104. The simulation may end when an error is encountered, a used defined time limit is reached or other appropriate criteria of a particular application. The simulation results (e.g., the signals SLN and SP) may then be reported at the simulation results block 108 via the signal RESULT. The process 100 may be repeat as necessary via the signal REPEAT.

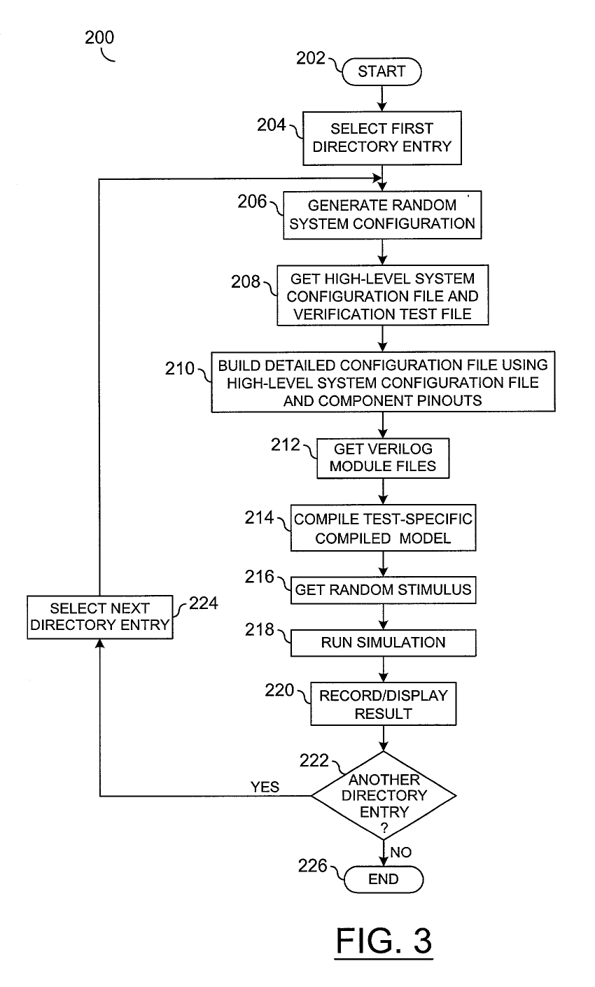

Referring to FIG. 3, an process (or method) 200 illustrating an operation of the system 100 is shown. The process 200 generally comprises a state 202, a state 204, a state 206, a state 208, a state 210, a state 212, a state 214, a state 216, a state 218, a state 220, a decision state 222, a state 224, and a state 226. While in the state 202, the process 200 may start. While in the state 204, the process 200 may select a first directory entry (e.g., a first complex random system to test). While in the state 206, the process 200 may generate a random system configuration (e.g., the random system configuration generation block 102 may generate the file SCF). While in the state 208, the process 200 may receive a high-level system file and a verification test file (e.g., the system builder 104 may receive the file SCF). While in the state 210, the process 200 may build a detailed configuration file using the high-level system configuration file and component pinout (e.g., the system builder 104 may generate the netlist SLN and the system parameters SP).

While in the state 212, the process 200 may receive verilog module files (e.g., the target modules 150). While in the state 214, the process 200 may compile test specific complied model (e.g., the SVE 106 may generate a particular system under test). While in the state 216, the process 200 may receive random stimulus (e.g., the adaptive random stimulus generator and check block 152 may randomly generate the stimulus S). While in the state 218, the process 200 may run a simulation (e.g., the SVE 106 may run a simulation of the particular system under test, through the stimulus S and the response R). While in the state 220, the process 200 may record/display the result (e.g., the simulation results block 108 may display the results).

While in the decision state 222, the process 200 may determine if another directory entry (system configuration) is to be verified. If another entry (system configuration) is to be verified, the process 200 may continue to the state 224. While in the state 224, the process 200 may select another entry (system configuration). The process generally loops from the decision state 222 back to the state 206 until interrupted by a user. The process 200 may then return to the state 206. If another entry (system configuration) is not to be verified, the process 200 may then continue to the end state 226.

The system 100 may provide automated system creation, stimulus, and verification to significantly increase the number and variety of possible system structures, configurations, and bus traffic combinations that are testable given limited time, personnel, and computing resources. The SVE 106 may be configured to automatically generate, stimulate and verify randomly created systems (e.g., the file SCF) with the target modules block 150. The stimulus S and response R generated to test the target modules 150 may be automatically and randomly adapted to the randomly generated system (SCF). The system 100 may generate combinations that are likely to include scenarios not (i) tested or anticipated by the designer/verifier in a directed verification test program or (ii) tested during current approaches to random verification.

The function performed by the system 100 of FIGS. 1, 2 and 3 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, and magneto-optical disks, ROMs, RAMs, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. An apparatus comprising:
a system configuration generator configured to generate a random system configuration file of a structurally variable and complex system;
a system builder configured to build a system level netlist in response to said random system configuration file; and
a simulation verification environment configured to verify said structurally variable and complex system in response to said system level netlist, wherein said simulation verification environment is configured to provide automatic random verification of said structurally variable and complex system in response to said random system configuration file.

2. The apparatus according to claim 1, wherein said simulation verification environment is further configured to provide adaptive random stimulus generation and checking.

3. The apparatus according to claim 2, wherein said simulation verification environment is further configured to test one or more target modules.

4. The apparatus according to claim 3, wherein simulation verification environment is further configured to provide adaptive random verification of said target modules.

5. The apparatus according to claim 1, wherein said system builder is further configured to generate system parameters.

6. The apparatus according to claim 5, wherein said simulation verification environment is further configured in response to said system parameters.

7. The apparatus according to claim 5, wherein said system configuration file specifies a randomly generated system comprising bus functional models, target modules and interconnections between said bus functional models and said target modules.

8. The apparatus according to claim 1, wherein said simulation verification environment comprises:
an adaptive random stimulus generator and checker configured to interface one or more target modules to verify said random system configuration file.

9. The apparatus according to claim 8, wherein said target modules and said adaptive random stimulus generator and checker are configured to interface stimulus and responses.

10. An apparatus comprising:
means for generating a system configuration file of a structurally variable and complex system;
means for building a system level netlist in response to said random system configuration file;
means for verifying said structurally variable and complex system in response to said system level netlist; and
means for providing automatic random verification of said structurally variable and complex system in response to said system configuration file.

11. A method for automated random verification of structurally variable and complex systems, comprising the steps of:
(A) generating a random system configuration file of said system;
(B) generating one or more parameters of said system in response to said random system configuration file;
(C) generating a system level netlist of said system in response to said random system configuration file;
(D) verifying one or more target modules with said system in response to said system level netlist; and
(E) automatically and randomly adjusting step (D) in response to said random system configuration file.

12. The method according to claim 11, wherein step (D) is further responsive to said system parameters.

13. The method according to claim 11, wherein said system configuration file specifies a randomly generated system comprising bus functional models, target modules and interconnections between said bus functional models and said target modules.

14. The method according to claim 11, wherein step (D) further comprises:
interfacing said random system configuration file to verify target modules.

15. The method according to claim 11, wherein step (A) further comprises:
randomly generating said random system configuration file.

16. The method according to claim 11, wherein step (E) further comprises:
repeating steps (A), (B), (C) and (D).

17. The method according to claim 11, wherein step (A) further comprises:
selecting a structurally variable and complex system.

18. A computer readable medium configured to perform the steps (A), (B), (C) and (D) of claim 11.
